(19) United States
(12) Patent Application Publication
(10) Pub. No.: US 2025/0183567 A1
(43) Pub. Date: Jun. 5, 2025

(54) CONNECTOR WITH INSULATION PERFORATION

(71) Applicant: SOCIETE INDUSTRIELLE DE CONSTRUCTION D'APPAREILS ET DE MATERIEL ELECTRIQUES (SICAME), Arnac-Pompadour (FR)

(72) Inventors: Aurélien CHEVALIER, Arnac-Pompadour (FR); Damien CARKA, Arnac-Pompadour (FR); Mathieu BONO, Arnac-Pompadour (FR)

(73) Assignee: SOCIETE INDUSTRIELLE DE CONSTRUCTION D'APPAREILS ET DE MATERIEL ELECTRIQUES (SICAME), Arnac-Pompadour (FR)

(21) Appl. No.: 18/968,759

(22) Filed: Dec. 4, 2024

(30) Foreign Application Priority Data
Dec. 3, 2023 (FR) 2314001

(51) Int. Cl. H01R 11/24

(52) U.S. Cl. CPC H01R 11/24

(57) ABSTRACT

A connector with two jaws, each including a channel receiving a main electric cable and which are able to move between a separated position and a clamped position, clamping means holding the jaws in the clamped position, at least one passage intended for inserting a secondary electric cable, for each jaw a sub-jaw with teeth disposed at the channel, and, for each sub-jaw, a spring element exerting a force against the sub-jaw at a bearing zone, wherein each passage emerges at the bearing zone and spring element so as to enable the secondary electric cable to be inserted between the bearing zone and the spring element.

### TECHNICAL FIELD

The present invention relates to a connector with insulation perforation that provides the electrical connection between a main electric cable the insulation of which is perforated and at least one secondary electric cable one end of which is bared. Such a connector can be used for example for connecting photovoltaic panels to a bus cable.

### PRIOR ART

It is often necessary to provide electrical continuity between various electric cables. To do this, numerous types of connector are used that are not always entirely satisfactory.

### DISCLOSURE OF THE INVENTION

One object of the present invention is to propose a connector having a different architecture that among other things provides simplified use and the concentration of a clamping force at the perforation of a main electric cable.

For this purpose, a connector is proposed comprising:
two jaws, each comprising a channel intended to receive a main electric cable, wherein the jaws are movable between a separated position and a clamped position.
clamping means arranged to hold the jaws in the clamped position.
for at least one jaw, at least one passage intended for inserting a secondary electric cable,
for each jaw, a sub-jaw having teeth made from electrically conductive material, disposed at the channel and oriented towards the other sub-jaw, and
for each sub-jaw, a spring element arranged so as to exert a force against the sub-jaw at a bearing zone of the sub-jaw, wherein, for each passage, said passage emerges at the bearing zone and spring element so as to enable the secondary electric cable to be inserted between the bearing zone and the spring element.

With such an arrangement, the force used for implementing the clamping is fully applied to the teeth to perforate the sheath of the main electric cable rather than to the secondary electric cables.

Advantageously, each sub-jaw is able to move in translation between a close-together position in which the teeth of the two sub-jaws are close to one another and a separated position in which the teeth of the two sub-jaws are separated from one another, and the force exerted by the spring element pushes the sub-jaw into the close-together position.

Advantageously, the spring element consists of at least one metal elastic blade.

Advantageously, the spring element comprises at least one wall having a housing, for each housing the sub-jaw has a protrusion housed in said housing and edges of the housing define the close-together and separated positions of the sub-jaw.

Advantageously, the connector comprises, for each sub-jaw, a gasket secured to the corresponding jaw, having, for each tooth, a tunnel through which said tooth passes, the gasket is produced from a flexible material.

Advantageously, the clamping means take the form of a threaded rod and at least one nut, each jaw has a chimney passing through said jaw, the threaded rod is disposed in the chimneys and said at least one nut is screwed onto the threaded rod so as to sandwich the two jaws.

Advantageously, the connector comprises at least one barrel secured to at least one jaw, produced from a flexible material and disposed between the two jaws around the threaded rod.

Advantageously, at each end of each channel, the jaw in question comprises two arms, wherein each arm has a proximal end secured to the jaw and a free distal end, and, in the clamped position, the arms are intended to be in abutment against the main electric cable.

### BRIEF DESCRIPTION OF THE DRAWINGS

The features of the invention mentioned above, as well as others, will emerge more clearly from the reading of the following description of an example embodiment, said description being made in relation to the accompanying drawings, among which:

FIG. 1 is a perspective view of a connector according to the invention in the separated position,

FIG. 2 is a perspective view of the connector according to the invention in the clamped position,

FIG. 3 is a perspective view in cross section along the plane III of FIG. 2 of a jaw of the connector according to the invention,

FIG. 4 is a view in cross section along the line IV-IV of FIG. 3,

FIG. 5 is a side view of the connector according to the invention,

FIG. 6 is a view in cross section along the plane VI of FIG. 2 of the connector according to the invention, and

FIG. 7 is an exploded view of a part of a jaw of the connector according to the invention.

### DETAILED DISCLOSURE OF EMBODIMENTS

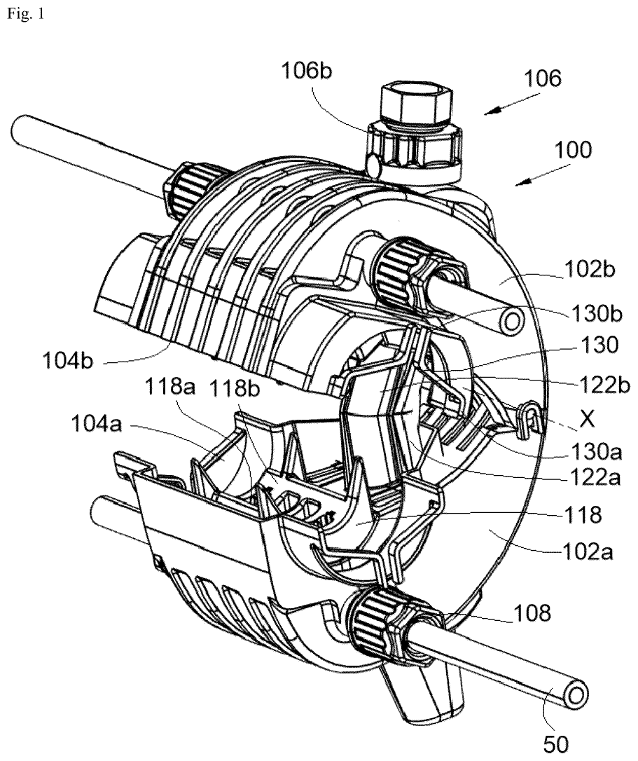

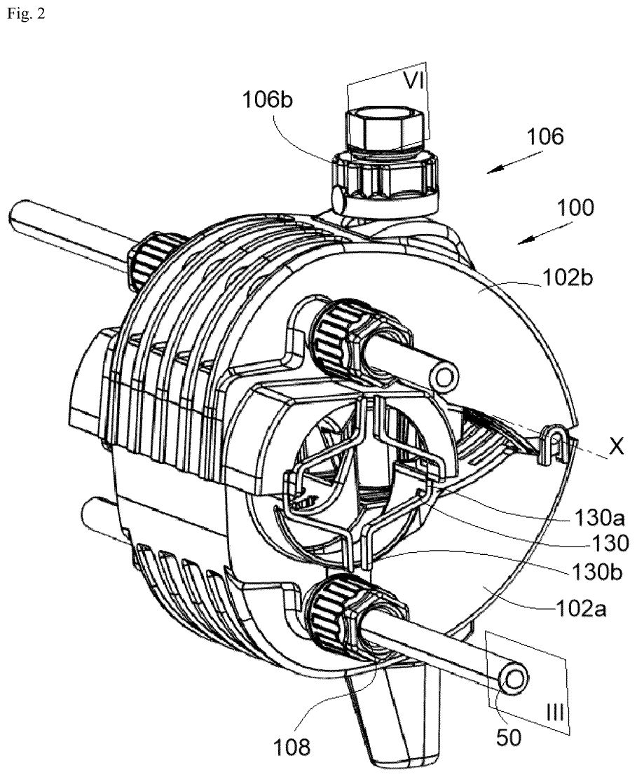

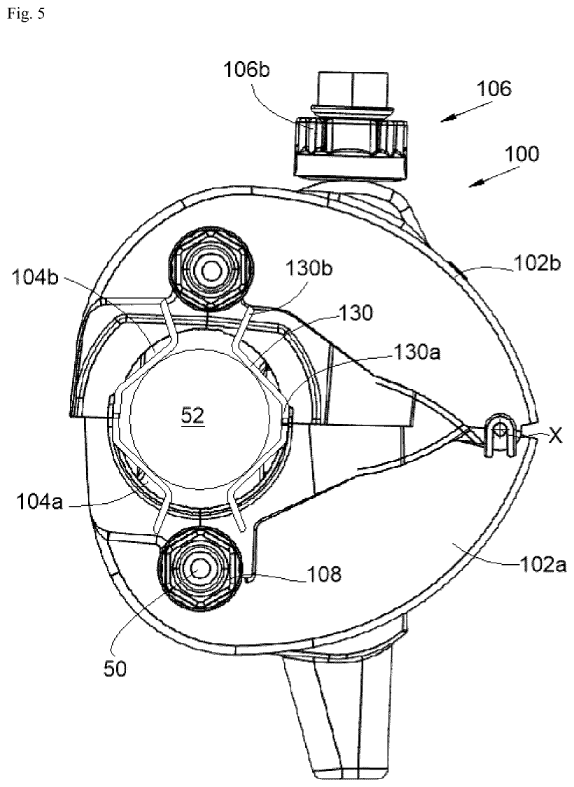

FIGS. 1 to 3 show a connector 100 according to the invention in various positions, namely in the separated position in FIG. 1, in the clamped position in FIG. 2 and in the clamped position and with a main electric cable 52 in FIG. 5.

The connector 100 thus comprises two jaws 102a-b and each comprising a channel 104a-b wherein the main electric cable 52 is received, which may for example be a bus cable. The jaws 102a-b are movable with respect to each other between a separated position and a clamped position. In the separated position, the two jaws 102a-b are separated to leave access to the channels 104a-b free and to enable the main electric cable 52 to be placed in the channels 104a-b. In the clamped position, the two jaws 102a-b are brought together to grip and hold the main electric cable 52.

In the embodiment of the invention presented here, the jaws 102a-b are mounted so as to be able to rotate with respect to each other about an articulation axis X that is roughly parallel to an axis of the main electric cable 52 when the latter is in place. In another embodiment of the invention that is not shown, the jaws 102a-b are mounted so as to be able to translate with respect to each other, for example by placing a slider connection between them, the direction of translation of which is perpendicular to the axis of the main electric cable 52 when the latter is in place.

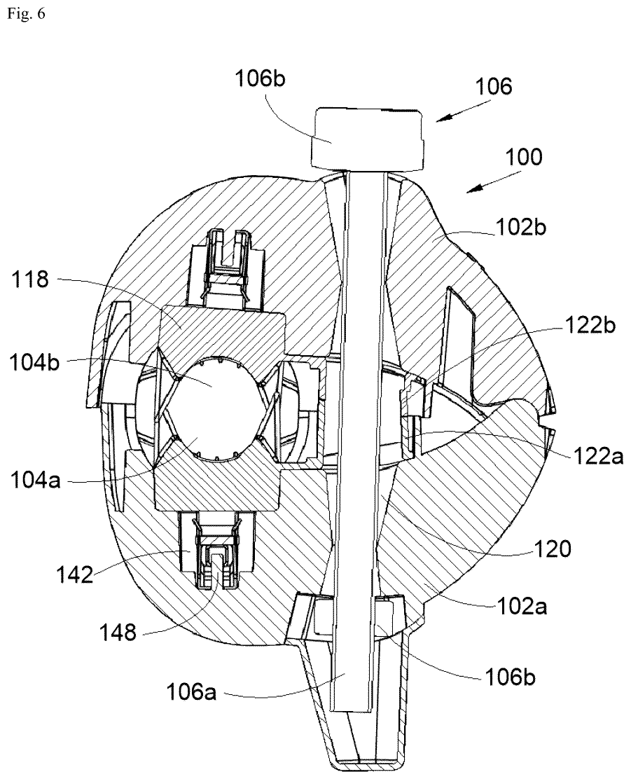

The connector 100 also comprises clamping means 106 that are arranged to hold the jaws 102a-b in the clamped position. In the embodiment of the invention presented here, and as shown more precisely in FIG. 6, the clamping means 106 here take the form of a threaded rod 106a and of at least one nut 106b screwed onto the threaded rod 106a.

Each jaw 102a-b thus has a chimney 120 passing through it, in which the threaded rod 106a is housed. In the embodiment of the invention presented in FIG. 6, there is a screw head 106b at one of the ends of the threaded rod 106a and a nut 106b screwed at the other end of the threaded rod 106a and the screw head 106b and the nut 106b bear on a rim of a jaw 102a-b and, after the nut 106b is tightened, the two jaws are sandwiched and clamped between the screw head 106b and the nut 106b. Naturally it is possible to make provision for replacing the screw head with a nut screwed onto the threaded rod.

Tightening the nuts or nuts 106b provides the clamping of the jaws 102a-b together in the clamped position, and slackening the nut or nuts 106b provides the release of the jaws 102a-b, which can go into the separated position.

In the embodiment of the invention presented here, each jaw 102a-b comprises two passages 108 that are designed to enable a secondary electric cable 50 to be inserted, which, as explained below, ensures electrical continuity between the main electric cable 52 and each secondary electric cable 50. In general terms, at least one jaw 102a-b is equipped with at least one passage 108. Each secondary electric cable 50 is for example a cable coming from a photovoltaic panel.

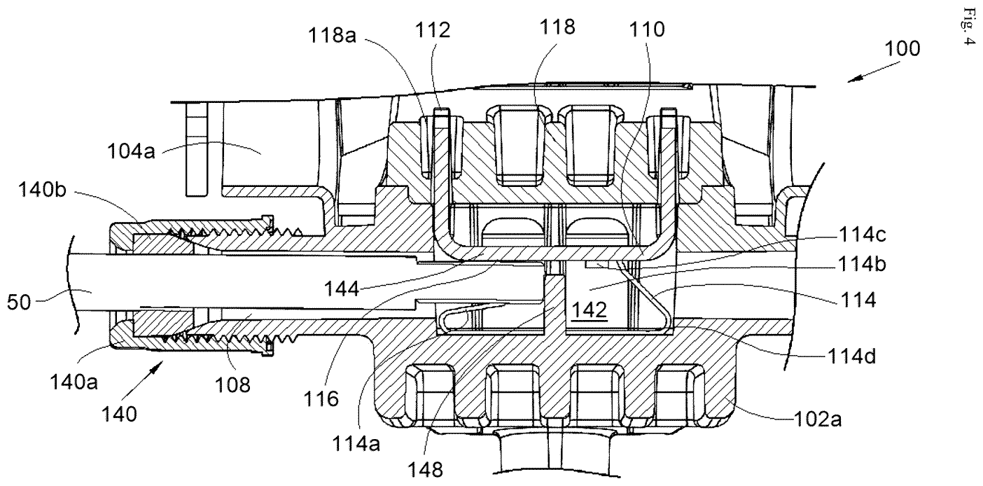

As can be seen better on FIG. 4, the passage 108 provides the passage between the exterior and a free space 142 provided inside the jaw 102a-b in question.

In the embodiment of the invention presented here, the connector 100 comprises, for each passage 108, a locking system 140 that locks the secondary electric cable 50 in question. The locking system 140 takes the form of a ring 140a screwed onto the jaw 102a-b and a locking wedge 140b.

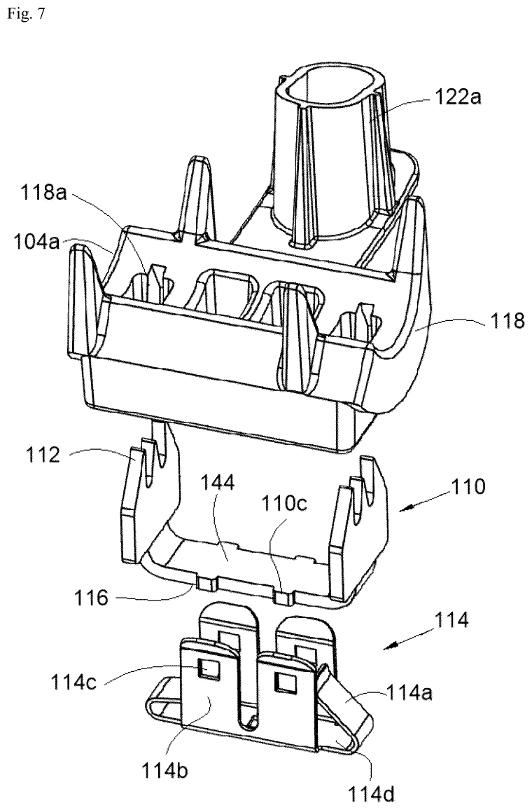

The connector 100 also comprises, for each jaw 102a-b, a sub-jaw 110 that is seen better in FIG. 7.

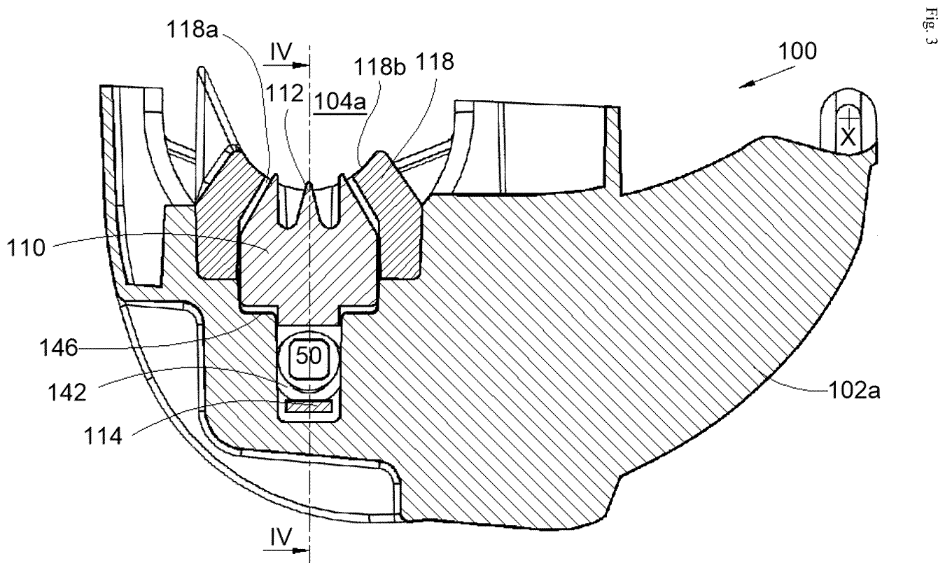

The sub-jaw 110 is housed in the free space 142 provided for this purpose in the jaw 102a-b and which is seen better on FIGS. 3 and 6.

Each sub-jaw 110 has teeth 112 that are produced from an electrically conductive material, typically from metal, and that are disposed at the channel 104a-b corresponding to said jaw 102a-b. The teeth 112 are oriented towards the other sub-jaw 110 and are arranged so that, when the jaws 102a-b are in the clamped position, they penetrate the sheath protecting the main electric cable 52 in order to establish contact with the conductive part of said main electric cable 52.

The connector 100 also comprises, for each sub-jaw 110, a spring element 114, preferentially made from electrically conductive material. The spring element 114 is disposed in the free space 142 and is in abutment against a wall delimiting the free space 142 of the jaw 102a-b in question. The spring element 114 is arranged so as to exert a force against the sub-jaw 110 at a bearing zone 116 of said sub-jaw 110 and is disposed so as to push the teeth 112 of the sub-jaw 110 towards the teeth 112 of the other sub-jaw 110 to clamp the main electric cable 52 between them and to come into contact with its conductive part.

For each passage 108, the passage 108 emerges in the free space 142 at the bearing zone 116 and spring element 114 so as to enable a bared end of the secondary electric cable 50 to be inserted between the bearing zone 116 and the spring element 114 so that the secondary electric cable 50 is in contact with the teeth 112 at the bearing zone 116 and therefore with the main electric cable 52 through the teeth 112.

The end of each secondary electric cable 50 is thus gripped between the spring element 114 and the bearing zone 116. The spring element 114 thus provides the pressure of the secondary electric cable 50 against the bearing zone 116 and therefore the electrical connection with the sub-jaw 110 and therefore the main electric cable 52.

Thus such a connector 100 ensures the connection of each secondary electric cable 50 with the main electric cable 52. Furthermore, with such an installation, it is possible to prepare the secondary electric cable 50 in the workshop and, during the clamping of the clamping means 106, the force used for effecting the clamping is fully applied to the teeth 112 to perforate the sheath of the main electric cable 52 and not to the secondary electric cables 50, which therefore do not risk being ruined.

The jaws 102a-b are produced from an electrically insulating material such as polyamide in order to enclose the sub-jaws 110 and thus avoid leakage currents.

In the embodiment of the invention presented here, the teeth 112 are distributed in two groups parallel to the articulation axis X and the groups are connected by a junction bar 144 parallel to the articulation axis X of the sub-jaw 110 also made from electrically conductive material, and the bearing zone 116 is disposed at the junction bar 144. In each group, there are a plurality of teeth 112 distributed perpendicularly to the articulation axis X.

In the embodiment of the invention presented here, the spring element 114 is produced from a metal spring blade conformed and folded with two metal elastic strips 114a. In general terms, there is at least one metal elastic strip 114a.

Here there are two elastic strips 114a to ensure the placing of a secondary electric cable 50 on each side and to ensure stability of the sub-jaw 110 by pushing at the two bearing zones 116. Because of the positioning of the spring element 114, the sub-jaws 110 are able to move in translation, here perpendicularly to the axis of the main electric cable 52 when it is in place, between a close-together position and a separated position.

The movement of the sub-jaws 110 is limited here, firstly by a rim 146 produced by the jaw 102a-b where the sub-jaw 110 is housed, and secondly by a gasket 118 secured to said jaw 102a-b and the prime function of which is explained below. The function of the gasket 118 of limiting the movement of the sub-jaws 110 can be fulfilled by another rim of the jaw 102a-b arranged for this purpose.

In the close-together position, the teeth 112 of the two sub-jaws 110 are close to one another and in the separated position the teeth 112 of the two sub-jaws 110 are distant from one another, and the force exerted by the spring element 114 pushes the teeth 112 into the close-together position.

Thus the teeth 112 always have a tendency to tighten around the main electric cable 52, and the mobility of the teeth 112 compensates for any dimensional variations that might appear over the course of time.

In the embodiment of the invention presented here, the spring element 114 comprises at least one wall 114b having a housing 114c and, for each housing 114c, the sub-jaw 110 has a protrusion 110c, produced here in the junction bar 144 and housed in said housing 114c, which here takes the form of a rectangular window. Here there are two walls 114b, four housings 114c, 110c distributed in pairs on each wall 114b and four protrusions 110c distributed in pairs on either side of the junction bar 144.

The edges of the housing 114c define the close-together and separated positions of the sub-jaw 110 by putting the protrusion 110c in abutment against said edges.

The spring element 114 also here has a bottom wall 114d to which the walls 114b and the elastic strips 114a are secured and wherein the bottom wall 114d is secured to the jaw 102a-b here by inserting a stud 148 on the jaw 102a-b in a bore provided for this purpose in the bottom wall 114d. The bottom wall 114d comes into abutment against the wall delimiting the free space 142 of the jaw 102a-b in question.

To provide electrical insulation of the teeth 112 with regard to a technician manipulating the connector 100, the latter comprises, for each sub-jaw 110, the gasket 118 that is secured to the jaw 102a-b corresponding to the sub-jaw 110.

The gasket 118 is produced from an electrically insulating flexible material, such as TPE, and has, for each tooth 112, a tunnel 118a through which said tooth 112 passes. Thus each tooth 112 passes through the gasket 112. In a particular embodiment, in the separated position, each tooth 112 is roughly flush with a contact surface 118b of the gasket 118, wherein said contact surface 118b is the surface that is facing the contact surface 118b of the other gasket 118, i.e. the gasket 118 that is on the other jaw 102b-a.

Because of the flexibility of the gasket 118, when the jaws 102a-b pass into the clamped position, the gasket 118 is gradually crushed by the sheath of the main electric cable 52, revealing the teeth 112 that pierce said sheath.

Each contact surface 118b partly delimits the channel 104a-b receiving the main electric cable 52.

In the embodiment of the invention presented in here, there is a tunnel 118a for several teeth 112.

To increase the leakage path between the teeth 112 and the threaded rod 106a when the latter is produced from electrically conductive materials, the connector 100 comprises at least one barrel 122a-b secured to at least one jaw 102a-b and disposed between the two jaws 102a-b around the threaded rod 106a.

The or each barrel 122a-b is produced from electrically insulating flexible material and thus, when the jaws 102a-b separate or clamp, the barrel or barrels 122a-b can adapt in length to the distance between the jaws 102a-b.

In the embodiment of the invention presented here and more particularly in FIG. 6, there is one barrel 122a-b for each jaw 102a-b and each barrel 122a-b is in a single piece with the gasket 118 associated with said jaw 102a-b.

To limit the possibility of contact with the teeth 112 when the main electric cable 52 is in place, and thus to increase the leakage path between the active parts and any other accessible part, provision is made for, at each end of each channel 104a-b, the jaw 102a-b in question to comprise two arms 130, where each arm 130 has a proximal end 130a secured to the jaw 102a-b and a free distal end 130b.

The arrangement of the arms 130 is such that, in the clamped position, the arms 130 are in abutment against the main electric cable 52.

In the embodiment of the invention presented here and more particularly in FIGS. 2 and 5, the two arms 130 associated with one and the same jaw 102a-b form a Y, where the ends of the upper arms of the Y are the proximal ends 130a secured to the jaw 102a-b so as to be diametrically opposed with respect to the channel 104a-b, while the middle arm of the Y is formed by the two distal ends 130b disposed parallel to each other.

The two Ys that are on the same side of the channels 104a-b are disposed in opposite orientations. The main electric cable 52 is thus placed between the upper arms of the Ys and the middle arms of the Y separate as the jaws 102a-b tighten.

The invention claimed is:

1. A connector comprising:
two jaws, each comprising a channel intended to receive a main electric cable, wherein the jaws are movable between a separated position and a clamped position,
clamping means arranged to hold the jaws in the clamped position,
for at least one jaw, at least one passage intended for inserting a secondary electric cable,
for each jaw, a sub-jaw having teeth made from electrically conductive material, disposed at the channel and oriented towards the other sub-jaw, and
for each sub-jaw, a spring element arranged so as to exert a force against the sub-jaw at a bearing zone of the sub-jaw, wherein, for each passage, said passage emerges at the bearing zone and spring element so as to enable the secondary electric cable to be inserted between the bearing zone and the spring element.

2. The connector according to claim 1, wherein each sub-jaw is able to move in translation between a close-together position in which the teeth of the two sub-jaws are close to one another and a separated position in which the teeth of the two sub-jaws are separated from one another, and wherein the force exerted by the spring element pushes the sub-jaw into the close-together position.

3. The connector according to claim 1, wherein the spring element consist of at least one metal elastic strip.

4. The connector according to claim 3, wherein the spring element comprises at least one wall having a housing, wherein, for each housing, the sub-jaw has a protrusion housed in said housing and wherein edges of the housing define the close-together and separated positions of the sub-jaw.

5. The connector according to claim 1, wherein it comprises, for each sub-jaw, a gasket secured to the corresponding jaw, having, for each tooth, a tunnel through which said tooth passes, and wherein the gasket is produced from a flexible material.

6. The connector according to claim 1, wherein the clamping means take the form of a threaded rod and at least one nut, wherein each jaw has a chimney passing through said jaw, wherein the threaded rod is disposed in the chimneys and wherein said at least one nut is screwed onto the threaded rod so as to sandwich the two jaws.

7. The connector according to claim 6, wherein it comprises at least one barrel secured to at least one jaw, produced from a flexible material and disposed between the two jaws around the threaded rod.

8. The connector according to claim 1, wherein, at each end of each channel, the jaw in question comprises two arms, wherein each arm has a proximal end secured to the jaw and a free distal end, and wherein, in the clamped position, the arms are intended to be in abutment against the main electric cable.
